(19) United States
(12) Patent Application Publication
(10) Pub. No.: US 2005/0257816 A1
(43) Pub. Date: Nov. 24, 2005

(54) Gasket assembly for dishwasher and door assembly using the same

(75) Inventor: Kyung Lae Kim, Gyeongsangnam-do (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 10/959,305

(22) Filed: Oct. 7, 2004

(30) Foreign Application Priority Data
May 20, 2004 (KR) P 2004-35891

(51) Int. Cl. B08B 3/02

(52) U.S. Cl. 134/200; 134/201; 134/57 D; 134/58 D; 68/196

(57) ABSTRACT

A gasket assembly for preventing washing water from being leaked between a door and a tub, and a door assembly provided with the gasket assembly. The gasket assembly includes a rigid bracket, both ends to which hinge frames provided at both lower sides of a door liner are fixed; and a flexible gasket, integrally extended from the bracket and in tight contact with a lower inner surface of a tub, for preventing washing water and from escaping from the tub and from reducing noise levels external to the tub.

This application claims the benefit of Korean Application No. P2004-035981, filed on May 20, 2004, which is hereby incorporated by reference.

### BACKGROUND OF THE INVENTION

1. Field of the Invention

The present invention relates to a dishwasher, and more particularly, to a dishwasher having a gasket assembly, and to a door assembly provided with the gasket assembly, for preventing washing water from leaking between a door and a tub.

2. Discussion of the Related Art

Generally speaking, a dishwasher is an automatic device for spraying a solution of detergent liquid and washing water onto kitchenware, which automatically washes and then dries the kitchenware. Such a dishwasher typically includes a tub having a door formed at a front side; at least one rack, provided in the tub, for holding kitchenware thereon; a sump, provided beneath the tub, for collecting and recirculating the washing water; at least one sprayer, disposed under the rack, for spraying washing water onto the kitchenware on the rack; and a pump for pumping the washing water in the sump into the sprayer. The pump is driven, and then the sprayer sprays the washing water in the sump onto the kitchenware for washing, after which the washing water collects in the sump to be sprayed again.

The dishwasher requires a structure that prevents the washing water from leaking between the door and the tub, which is generally achieved using a gasket. A variety of such gaskets are used in contemporary dishwashers. The gasket is provided as a separate component, but a separately fabricated and installed gasket increases the number of parts of a manufactured dishwasher and complicates the assembly process, which increases manufacturing costs.

### SUMMARY OF THE INVENTION

Accordingly, the present invention is directed to a gasket assembly of a dishwasher that substantially obviates one or more problems due to limitations and disadvantages of the related art.

An object of the present invention is to provide a gasket assembly of a dishwasher having an improved structure that can prevent washing water from leaking between a door of the dishwasher and a tub, while reducing production costs and enhancing productivity.

Another object of the present invention is to provide a gasket assembly of a dishwasher having an improved structure that can both prevent washing water from leaking between a door of the dishwasher and a tub and reduce the noise external to the tub.

Another object of the present invention is to provide a gasket assembly of a dishwasher having an improved structure that reduces the number of components required for manufacturing a dishwasher.

Another object of the present invention is to provide a gasket assembly of a dishwasher having an improved structure that provides for an integrally formed gasket assembly.

Another object of the present invention is to provide a door assembly of a dishwasher provided with the above gasket assembly.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a gasket assembly of a dishwasher, comprising a rigid bracket, both ends to which hinge frames provided at both lower sides of a door liner are fixed; and a flexible gasket, integrally extended from the bracket and in tight contact with a lower inner surface of a tub, for preventing washing water and from escaping from the tub and from reducing noise levels external to the tub.

In another aspect of the present invention, there is provided a door assembly of a dishwasher, comprising a door liner disposed at a front side of a door; hinge frames respectively coupled to both lower sides of the door liner and rotating with respect to a hinge shaft; a bracket having both ends fixed to the hinge frames and allowing the hinge frames to be spaced apart from each other by a predetermined interval; and a gasket, integrally extended from a lower side of the bracket and in tight contact with a lower inner surface of the tub, for preventing washing water and from escaping from the tub and from reducing noise levels external to the tub.

The bracket may include: an upper part connected with the respective hinge frames and disposed vertically in front of the door liner; and a lower part integrally extended from a lower side of the upper part and connected with a lower end of the door liner. It is preferable that the lower part is in tight contact with a lower side of the door liner. The gasket is integrally extended from a front side of the lower part.

The door liner may include: a recess formed at a lower front side thereof and in tight contact with a lower side of the bracket; and a lip for receiving and fixing a lower end of the bracket. The recess may be formed by a sloped surface disposed at a lower front side of the door liner, and a lip extension extended forward from a lower side of the sloped surface, the door liner having a thickness that decreases toward its lower end.

The hinge frame may include: a first fixing part coupled to a lower side of the door liner; a second fixing part extending from the first fixing part, spaced apart by a predetermined distance from a front side of the door liner, and to which one end of the bracket is fixed; and an opening provided at a lower side of the hinge frame and into which the hinge shaft is inserted. The hinge frame may further include a hook extended rearward from a lower side of the hinge frame, to be connected with one end of an elastic member whose other end is connected to the tub.

The gasket may have a distal end curved upwardly to make contact with a lower front inner surface of the tub. The bracket may be formed of a hard synthetic resin, and the gasket may be formed of a soft synthetic resin. The bracket and gasket are integrally formed by injecting a hard synthetic resin and a soft synthetic resin into a single mold.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a schematic view of a dishwasher according to the present invention;

FIG. 2 is a perspective view of a lower part of a door assembly in the dishwasher of FIG. 1;

FIG. 3 is a sectional view of a lower part of a door assembly in the dishwasher of FIG. 1; and

FIG. 4 is a sectional view of a gasket assembly employed in a door assembly of FIGS. 2 and 3.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

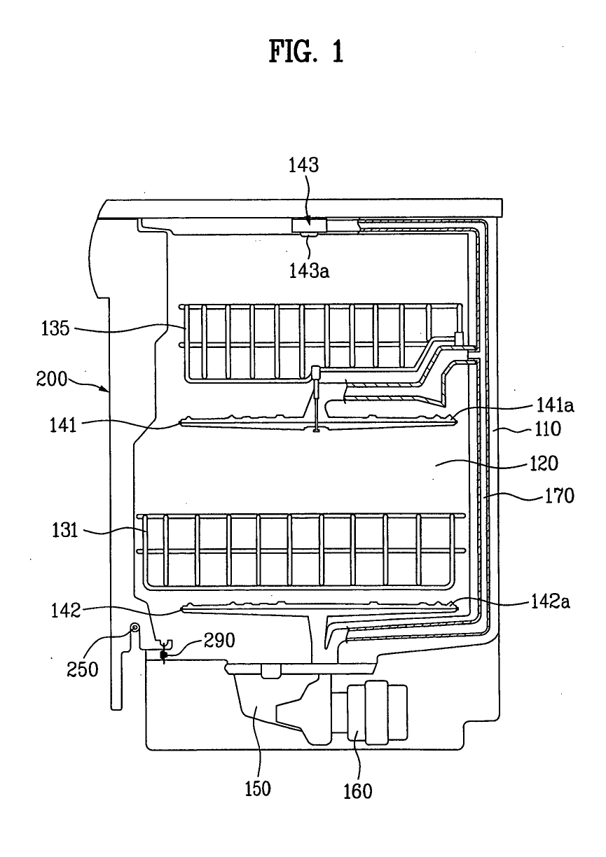

Referring to FIG. 1, illustrating a dishwasher according to the present invention, a washing chamber 120 is provided inside a tub 110 having an open front side, and a door assembly 200 is disposed at an open front side of the tub 110 and opens and closes the washing chamber 120 by rotating on a hinge shaft 250. When the door assembly 200 is opened, upper and lower racks 135 and 131 can be individually drawn out of the washing chamber 120 through the open front side of the tub 110. The present invention is applicable to a dishwasher having one or more racks.

A sump 150, provided under the washing chamber 120, receives clean water fed from an external source, e.g., a household water tap, connected to the dishwasher via a feeding hose (not shown) and a feeding valve (not shown). The sump 150 also collects used washing water draining off the items being washed, the racks, and interior surfaces of the washing chamber 120. A filter (not shown) is connected to the sump 150 to filter the used washing water.

The sump 150 is connected with a pump 160 that pumps the washing water received in the sump 150. The pump 160 includes a motor (not shown) connected to one side of the sump 150 and an impeller (not shown) coupled with the motor. The motor rotates the impeller, which is disposed within the sump, to pump the washing water received in the sump 150.

Upper, lower, and top sprayers 141, 142, and 143, which are provided with nozzles 141a, 142a, and 143a, respectively, are disposed within the washing chamber 120 and each communicate with the pump 160 via a set of water pipes 170. The present invention is applicable to a dishwasher having one or more sprayers.

When the pump 160 is driven, the washing water pumped from the sump 150 is supplied through the water pipes 170 to each of the sprayers 141, 142, and 143 simultaneously, and the washing water is sprayed into the washing chamber 120 via the nozzles 141a, 142a, and 143a. The upper and lower sprayers 141 and 142 spray the washing water upward, and the top sprayer 143 sprays the washing water downward. The nozzles 141a, 142a, and 143a are formed to spray the washing water at a uniform angle, and the sprayers 141, 142, and 143, which are rotatably installed, react to the forces generated by the angled spraying of the washing water and thus spin when the pump 160 is driven. Therefore, the washing water sprayed from the nozzles 141a, 142a, and 143a is evenly dispersed in the washing chamber 120, to achieve a thorough washing action throughout the upper and lower racks 135 and 131.

Meanwhile, the washing water is sprayed under high pressure, which generates noise and creates a potential for leakage between the tub 110 and the door assembly 200. To reduce the noise levels experienced outside the dishwasher and to prevent the leakage of washing water, the dishwasher of the present invention is provided with a gasket assembly at the door assembly 200.

A structure of the door assembly 200 provided with the gasket assembly will now be described with reference to FIGS. 1 to 4.

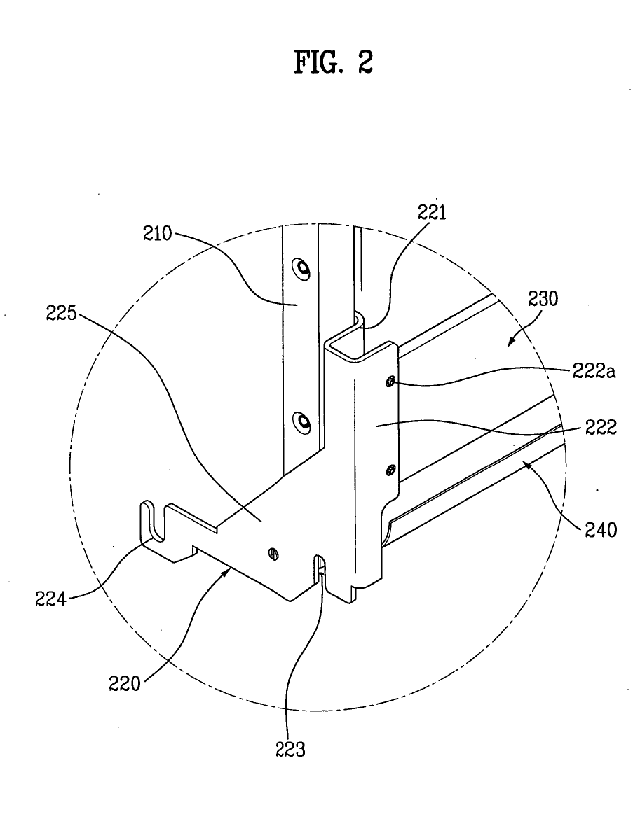

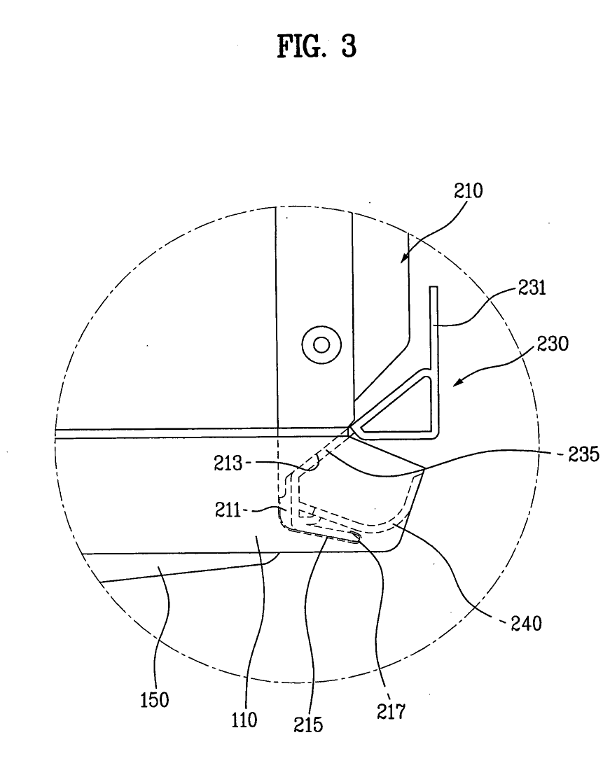

The door assembly 200 includes a door liner 210 and an outer panel (not shown). The door liner 210 is disposed in a direction facing a front side of the tub 110. The door liner 210 forms an inner frame of the door assembly 200, facing the tub 110 (refer to FIG. 1). The outer panel forms an outer surface of the door assembly 200 and, though not shown in the drawings, is provided on the front side of the door liner 210, facing outward, i.e., to the right of the door liner as shown in FIGS. 2 and 3.

The door assembly 200 also includes a hinge assembly at a lower portion. The hinge assembly includes a hinge shaft 250 (refer to FIG. 1) and a pair of hinge frames 220 rotatably coupled with the hinge shaft 250. Each hinge frame 220 is fixed, using a first vertical fixing part 221 and a connecting means (e.g., screws or bolts), to a lower side of the door liner 210. The hinge frame 220 is provided with a slotted opening 223, extending upwardly from a lower edge of the hinge frame, into which the hinge shaft 250 is inserted. Here, the opening 223 may be formed as an enclosed hole perforating a lower portion of the hinge frame 220. The hinge frame 220 may be provided with a hook 224, as shown in FIG. 2, which extends horizontally from a lower side of the hinge frame 220 toward the tub 110, i.e., rearward. A reinforcing member 225 may be provided at the junction of the hook 224 and the first vertical fixing part 221.

Coupled to the hook 224 is an elastic member 290, which may be made of a tensile spring that gains elastic energy when loaded, i.e., stretched. When installed, one end of the elastic member 290 may be fixed to a lower side of the tub 110, and the other end thereof may be fixed to the hook 224. When the hook 224 and the elastic member 290 are provided as above, a sudden opening of the door, which may impart an excessive change in the dishwasher's center of gravity and result in accidental tipping, can be prevented while facilitating the door's closing. That is, as the door is opened, the hinge frame 220 rotates together with the door liner 210, pivoting on the hinge shaft 250 such that the hook 224 swings upward and loads the elastic member 290 provided between the tub 110 and hook. The hinge frame 220 and the door liner 210 rotate in the opposite direction when the door is closed, such that the elastic member 290 contracts and pulls the hinge frame 220 due to the gained elastic energy, thereby provided an assisted closing action.

The gasket assembly is installed on the hinge frame 220 to prevent washing water inside the tub 110 and noise from being leaked. A second fixing part 222 is provided at the hinge frame 220 to fix the gasket assembly.

As shown in FIG. 2, the second fixing part 222 extends forward from the first fixing part 221 and has a forward side arranged in parallel with the first fixing part, the forward side being spaced apart from a front side of the door liner 210 by a predetermined distance. At least one hole 222a is formed in the forward side of the second fixing part 222, providing a convenient fixing point for the gasket assembly using a connecting means (e.g., screw or bolts).

The gasket assembly mounted on the second fixing part 222 of the hinge frame 220 includes a bracket 230 and a gasket 240, which are integrally formed as one body. The bracket 230 is rigid and maintains a distance between the hinge frames 220, which are respectively provided at each lower side of the door liner 210, and the gasket 240 is flexible and prevents washing water inside the tub 110 from leaking and reduces the external noise level.

The bracket 230 is formed of a hard material. As shown in FIG. 2, the ends of the bracket 230 are fixed to the second fixing part 222 of the hinge frame 220. As shown in FIG. 3, the bracket 230 includes a vertical upper part 231 and a lower part 235 integrally extended from a lower side of the vertical upper part. The vertical upper part 231 is formed as a long panel spaced apart from the door liner 210 by a predetermined distance and has its lateral ends connected to the hinge frame 220. As shown in FIG. 3, the lower part 235 is connected to a lower side of the door liner 210 and is inserted into a lower side of the tub 110. To allow for this insertion, the door liner 210 includes a recess 211 and a lip 217. The recess 211 is formed at a lower side of the door liner 210 and maintains a tight contact with the lower part 235 of the bracket 230. A lower end of the lower part 235 is inserted into and fixed to the lip 217, which curls upward from an end of the lip extension 215 into the recess 211 to receive the lower part 235 of the bracket 230.

As described above with reference to FIG. 3, a lower side of the door liner 210 is received in a lower inner surface of the tub 110, and the recess 211 is formed at a lower front side of the door liner. The recess 211 is formed by the lip extension 215 and a sloped surface 213. The sloped surface 213 is disposed at a lower front side of the door liner 210, such that the thickness of the door liner decreases toward its lower end, i.e., toward the recess 211. The lip extension 215 extends forward from a lower side of the sloped surface 213. Here, it is preferable that the lip extension 215 includes a vertical portion of a predetermined length, which extends directly downward from a lower side of the sloped surface 213, before extending forward from the lower end of the vertical portion, to thereby create the recess 211 formed between the sloped surface and the lip extension. The recess 211 is tightly contacted with the lower part 235 of the bracket 230. The lower part 235 can be firmly fixed to the recess 211 using a connecting means (e.g., screws or bolts). A lower end of the lower part 235 of the bracket 239 is fitted into and thereby fixed to the lip 217.

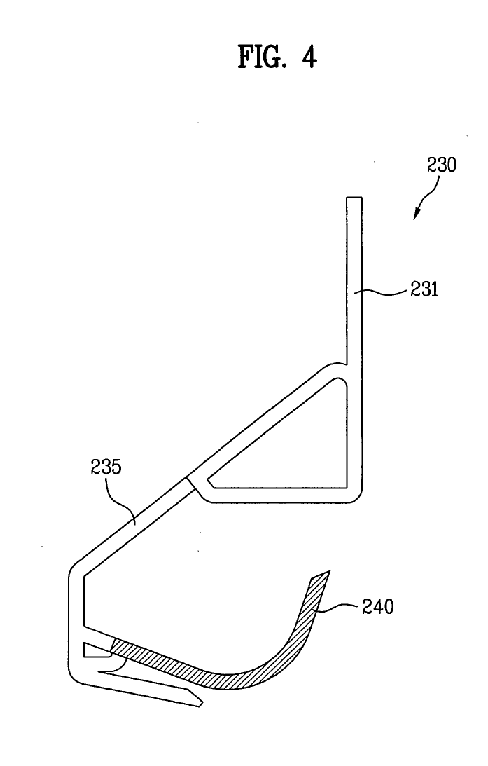

As shown in FIGS. 3 and 4, the gasket 240 is integrally extended from a forward side of a lower surface of the lower part 235 of the bracket 230. The gasket 240 is formed of a soft synthetic resin having a predetermined elasticity and stiffness. The gasket 240 has a distal end that curves upward to make contact with a lower front inner surface of the tub 110, so that washing water can be effectively prevented from leaking from the tub 110 and so that noise levels external to the tub can be effectively reduced.

While the gasket 240 is integrally formed with the bracket 230, the bracket is formed of a hard synthetic resin and the gasket is formed of a soft synthetic resin, for example, a rubber material. Accordingly, a dual injection method is used for integrally forming the gasket assembly, whereby two different materials, i.e., the hard synthetic resin of the bracket 230 and the soft synthetic resin of the gasket 240, are injected into a single mold, thus reducing the part count, simplifying manufacturing, and reducing assembling time.

In mounting the thus-molded gasket assembly onto the door assembly 200, and more particularly, onto the door liner 210, one end of the bracket 230 is first positioned at one side of the door liner 210. A lower side of the bracket 230, that is, an end of the lower part 235, is inserted into a lower side of the door liner 210, that is, the lip 217. Then, the gasket assembly is pushed laterally. Thus, the lower part 235 of the bracket 230 is put in tight contact with the recess 211 of the door liner 210, and an end of the lower part 235 is seated in the lip 217 of the door liner 210, thereby maintaining a set position. In such a state, the lower part 235 is fixed to the recess 211 using a connecting means. Thereafter, the hinge frame 220 is fixed to the sides of the door liner 210. To do so, both ends of the upper part 231 of the bracket 230 are fixed to the second fixing part 222 of the hinge frame 220 using a connecting means.

The door assembly 200, assembled as above, is connected to a hinge shaft 250 provided below the tub 110. A lower end of the door liner 210 is inserted into a lower side of the tub, and the gasket 240 makes tight contact with a lower front inner surface of the tub 110, as shown in FIG. 3. In this state, one end of the elastic member 290 is connected to a lower side of the tub 110 and the other end is connected to the hook 224 of the hinge frame 220. Accordingly, the door assembly 200 is rotatably mounted on a front surface of the tub 110.

According to the present invention, two parts having separate functions, that is, the bracket for maintaining distance of the hinge frame and the gasket for preventing washing water from leaking from the tub and for reducing external noise, are integrally formed. Therefore, the number of parts is reduced and assembly is simplified, thereby reducing manufacturing costs and improving productivity. In addition, an organic coupling of the hinge assembly and the gasket assembly reduces their assembly time.

It will be apparent to those skilled in the art that various modifications and variations can be made in the present invention. Thus, it is intended that the present invention covers the modifications and variations of this invention provided they come within the scope of the appended claims and their equivalents.

1. A gasket assembly of a dishwasher, comprising:
a rigid bracket, both ends to which hinge frames provided at both lower sides of a door liner are fixed; and
a flexible gasket, integrally extended from the bracket and in tight contact with a lower inner surface of a tub, for preventing washing water and from escaping from the tub and from reducing noise levels external to the tub.

2. The gasket assembly of claim 1, wherein the bracket comprises:
a vertical upper part connected with the respective hinge frames; and
a lower part integrally extended from a lower side of the upper part and connected with a lower end of the door liner.

3. The gasket assembly of claim 2, wherein the lower part is in tight contact with a lower side of the door liner.

4. The gasket assembly of claim 2, wherein the gasket is integrally extended from a front side of the lower part.

5. The gasket assembly of claim 1, wherein the gasket has a distal end curved upwardly to make contact with a lower front inner surface of the tub.

6. The gasket assembly of claim 1, wherein the door liner comprises a lower end, received in a lower inner surface of the tub, the door liner having a recess formed at a front side of the lower end such that the lower end of the bracket can be inserted and fixed to the door liner.

7. A door assembly of a dishwasher, comprising:
a door liner disposed at a front side of the door assembly;
a pair of hinge frames respectively coupled to both lower sides of the door liner and rotating with respect to a hinge shaft;
a bracket having both ends fixed to the hinge frames and allowing the hinge frames to be spaced apart from each other by a predetermined interval; and
a gasket, integrally extended from a lower side of the bracket and in tight contact with a lower inner surface of the tub, for preventing washing water and from escaping from the tub and from reducing noise levels external to the tub.

8. The door assembly of claim 7, wherein the bracket comprises:
an upper part connected with the respective hinge frames and disposed vertically in front of the door line; and
a lower part integrally extended from a lower side of the upper part and connected with a lower end of the door liner.

9. The door assembly of claim 8, wherein the lower part is in tight contact with a lower side of the door liner.

10. The door assembly of claim 8, wherein the gasket is integrally extended from a front side of the lower part.

11. The door assembly of claim 7, wherein the door liner comprises a lip for receiving and fixing a lower end of the bracket, wherein a recess is formed at a lower front side of the door liner and in tight contact with a lower side of the bracket.

12. The door assembly of claim 11, wherein the recess is formed by a sloped surface disposed at a lower front side of the door liner, and a lip extension extended forward from a lower side of the sloped surface, the door liner having a thickness decreasing toward a lower end of the door liner.

13. The door assembly of claim 7, wherein the hinge frame comprises:
a first fixing part coupled to a lower side of the door liner; and
a second fixing part extending from the first fixing part, spaced apart by a predetermined distance from a front side of the door liner, and to which one end of the bracket is fixed, wherein an opening is provided at a lower side of the hinge frame and into which the hinge shaft is inserted.

14. The door assembly of claim 13, wherein the hinge frame further comprises a hook extended rearward from a lower side of the hinge frame, to be connected with one end of an elastic member whose other end is connected to the tub.

15. The door assembly of claim 7, further comprising an elastic member, which is disposed between a lower side of the tub and the hinge frame, to expand and contract as the hinge frame rotates.

16. The door assembly of claim 7, wherein the gasket has a distal end curved upwardly to make contact with a lower front inner surface of the tub.

17. The door assembly of claim 7, wherein the bracket is formed of a hard synthetic resin.

18. The door assembly of claim 7, wherein the gasket is formed of a soft synthetic resin.

19. The door assembly of claim 7, wherein the bracket and gasket are integrally formed by injecting a hard synthetic resin and a soft synthetic resin into a single mold.
